(19) United States
(12) Patent Application Publication
(10) Pub. No.: US 2025/0178467 A1
(43) Pub. Date: Jun. 5, 2025

(54) APPARATUS FOR AND METHOD OF CHARGING ELECTRIC VEHICLE

(71) Applicants: Hyundai Motor Company, Seoul (KR); Kia Corporation, Seoul (KR)

(72) Inventor: Jin-Su Jang, Hwaseong-si (KR)

(21) Appl. No.: 18/767,301

(22) Filed: Jul. 9, 2024

(30) Foreign Application Priority Data
Dec. 4, 2023 (KR) 10-2023-0173465

(51) Int. Cl. B60L 53/22; B60L 53/16; B60L 53/60; H02J 7/00

(52) U.S. Cl. CPC B60L 53/22; B60L 53/16; H02J 7/0042; B60L 53/60; B60L 2210/30

(57) ABSTRACT

An embodiment apparatus for charging an electric vehicle includes a charging port, a detection block configured to generate a detection signal by detecting whether or not a charging connector of a charging facility is connected to the charging port, a charging controller configured to perform charging control using a first charging mode or a second charging mode according to the detection signal, and a relay box configured to separate charging power supplied from the charging facility into direct current power and alternating current power according to the charging control.

### CROSS-REFERENCE TO RELATED APPLICATIONS

This application claims the benefit of Korean Patent Application No. 10-2023-0173465, filed on Dec. 4, 2023, which application is hereby incorporated herein by reference.

### TECHNICAL FIELD

The present disclosure relates to a technology for charging an electric vehicle.

### BACKGROUND

In North America, an electric vehicle charging operation is currently broadly categorized into two types: a charging type for the Combined Charging System (CCS) and a charging type for the North American Charging Standard (NACS). The charging type for the CCS (“a CCS mode”) satisfies standards such as Society of Automotive Engineers (SAE) J1772, International Electrotechnical Commission (IEC) 62196, IEC 61815, International Organization for Standardization (ISO) 15118, and the like. The CCS mode makes it possible to perform alternating current/direct current (AC/DC) charging based on high-level communications between the electric vehicle and a charging equipment.

Tesla, Inc. has independently set up and managed charging connectors and communication specifications and has established an independent charging infrastructure, such as a super charger network. As of 2023, infrastructures of charging type currently established in North America consist of the CCS mode 50%, a Tesla mode 30%, and a CHAdeMo mode 20%, respectively.

However, in recent years, a Tesla type charging mode has been selected as a standard mode for the NACS. Many global automobile makers, such as GM and Ford, announced plans to adopt the Tesla type charging mode (“an NACS mode”) instead of the CCS mode.

In addition, local companies for establishing charging infrastructures also have plans to supply charging apparatuses complying with the Tesla type charging mode (the NACS mode). Therefore, electric vehicles scheduled for sale in North America are required to comply with the Tesla type charging mode.

Therefore, it is noted that charging apparatuses have been required to comply with both the standard for the Combined Charging System (the CCS mode) and the standard for the North American Charging Standard (the NACS mode).

### SUMMARY

The present disclosure relates to a technology for charging an electric vehicle. Particular embodiments relate to an apparatus for and a method of charging an electric vehicle that are applicable for both the Combined Charging System (CCS) and the North American Charging Standard (NACS).

One embodiment of the present disclosure, which addresses problems in the art, provides an apparatus for and a method of charging an electric vehicle that are applicable for both the CCS and the NACS.

Another embodiment of the present disclosure provides an apparatus for and a method of charging an electric vehicle that is capable of complying with the NACS.

Still another embodiment of the present disclosure provides an apparatus for and a method of charging an electric vehicle that is capable of performing a charging operation according to determination of an AC charging mode or a DC charging mode.

In order to accomplish the above-mentioned embodiments, according to one embodiment of the present disclosure, there is provided an apparatus for charging an electric vehicle capable of complying with both the standard for the CCS and the NACS.

The apparatus for charging an electric vehicle may include a charging port, a detection block generating a detection signal by detecting whether or not a charging connector of a charging facility is connected to the charging port, a charging control unit performing charging control using a first charging mode or a second charging mode according to the detection signal, and a relay box separating charging power, supplied from the charging facility, into direct current power and alternating current power according to the charging control.

In the apparatus, the first charging mode may include a mode complying with the North American Charging Standard (the NACS mode), and the second charging mode may include a mode complying with the standard for the Combined Charging System (the CCS mode).

Furthermore, the detection block may include a first detector installed at a first charging port complying with the NACS mode and detecting a connection to the charging connector and a second detector installed at a second charging port complying with the CCS mode and detecting the connection to the charging connector.

In the apparatus, the relay box may include an alternating current (AC) relay connected to an alternating current power line and allowing or disabling the flow of the alternating current power and a direct current (DC) relay configured in parallel with the AC relay, connected to a direct current power line, and allowing or disabling the flow of the direct current power.

In the apparatus, the AC relay and the DC relay may be arranged in the alternating current power line and the direct current power line, respectively, and each may include a plurality of switching elements.

In the apparatus, in a case where the charging control is performed using the second charging mode, the charging control unit may keep a line, from the second charging port complying with the CCS mode, connected to a connection point within the relay box by switching off both the AC relay and the DC relay.

In the apparatus, when the charging control is not performed using one of the first and second charging modes, the charging control unit may keep the AC relay and the DC relay switched off.

In the apparatus, after normally connecting the first charging port complying with the NACS mode or the second charging port complying with the CCS mode to the charging connector, based on a result of comparison of a control pilot (CP) duty with a preset reference value and based on whether or not a specific communication scheme is supported, the charging control unit may perform AC charging by switching on the AC relay or perform DC charging by switching on the DC relay.

In the apparatus, as a result of the comparison of the CP duty with the preset reference value, the AC charging may be performed based on low-level communication or high-level communication.

In the apparatus, according to whether or not the specific communication scheme is supported, either the AC charging or the DC charging may be performed, or only the DC charging may be immediately performed.

The apparatus may further include a junction box allowing or disabling the flow of the direct current power into a battery.

In the apparatus, the junction box may be arranged between the relay box and the battery, including a first junction switching element connected to a DC+ line and a second junction switching line connected to a DC− line.

The apparatus may further include an on-board charger receiving the alternating current power and converting the received alternating current power into direct current power.

The apparatus may further include a first contact point sensor detecting an open or closed state of a first charging door installed at a charging portion, complying with the first charging mode, of the charging ports and a second contact point sensor detecting an open or closed state of a second charging door installed at a charging portion, complying with the second charging mode, of the charging ports.

In the apparatus, the charging control unit may end the charging control when the second charging door is detected as being in the open state while the charging control is performed using the first charging mode or when the second charging door is detected as being in the open state while the charging control is performed using the second charging mode.

According to another embodiment of the present disclosure, there is provided a method of charging an electric vehicle including generating, by a detection block, a detection signal by detecting whether or not a charging connector of a charging facility is connected to a charging port, performing, by a charging control unit, charging control using a first charging mode or a second charging mode according to the detection signal, and separating, by a relay box, charging power supplied from the charging facility into direct current power and alternating current power according to the charging control.

In the method, the generating of the detection signal by the detection block may include detecting, by a first detector, a connection to the charging connector, the first detector being installed at a first charging port complying with the NACS mode, and detecting, by a second detector, the connection to the charging connector, the second detector being installed at a second charging port complying with the CCS mode.

In the method, the performing of the charging control by a charging control unit may include keeping, by the charging control unit, a line, from the second charging port complying with the CCS mode, connected to a connection point within the relay box by switching off both the AC relay and the DC relay, in a case where the charging control is performed using the second charging mode.

In the method, the performing of the charging control by the charging control unit may include keeping, by the charging control unit, the AC relay and the DC relay switched off when the charging control is not performed using one of the first and second charging modes.

Embodiments of the present disclosure may be applicable for both the standard for the CCS and the NACS using a separate high-voltage relay box.

In addition, embodiments of the present disclosure may charge an electric vehicle in compliance with the NACS using the separate high-voltage relay box.

In addition, embodiments of the present disclosure may perform a charging operation according to the result of determination of whether an AC charging mode or a DC charging mode is available.

### BRIEF DESCRIPTION OF THE DRAWINGS

FIG. 1 is a block diagram illustrating an exemplary embodiment of an electric vehicle charging system according to embodiments of the present disclosure.

FIG. 2 is a block diagram illustrating a configuration of a charging apparatus for an electric vehicle which is configured to be mounted in the electric vehicle illustrated in FIG. 1.

FIG. 3 is a block diagram illustrating detailed configurations of a relay box and a junction box, illustrated in FIG. 2, that are applicable for the North American Charging Standard (NACS).

FIG. 4 is a block diagram illustrating detailed configurations of the relay box and the junction box that are applicable for the Combined Charging System (CCS) and the NACS.

FIGS. 5 and 6 are flowcharts for performing the charging control by determining an AC charging mode and a DC charging mode according to an exemplary embodiment of the present disclosure.

FIG. 7 is a flowchart illustrating a process of communication between a charging facility and an electric vehicle according to an exemplary embodiment of the present disclosure.

### DETAILED DESCRIPTION OF ILLUSTRATIVE EMBODIMENTS

The objects, features, and advantages of embodiments of the present disclosure, which are mentioned above, will be described in detail below with reference to the accompanying drawings, and, from this description, the technical ideas of embodiments of the present disclosure will be readily implemented by a person of ordinary skill in the art to which the present disclosure pertains. In a case where a specific description of the well-known technology associated with the present disclosure is determined as unnecessarily making the nature and gist of the present disclosure obfuscated, a detailed description thereof will be omitted from the description of embodiments of the present disclosure.

Preferred embodiments of the present disclosure will be described in detail below with reference to the accompanying drawings. The same reference numbers are used in the drawings to indicate the same or similar constituent elements.

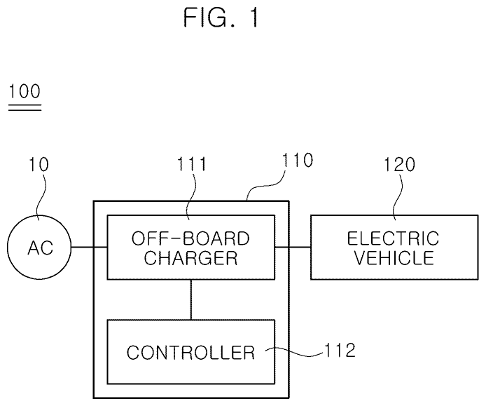

FIG. 1 is a block diagram for a configuration of an electric vehicle charging system 100. With reference to FIG. 1, the electric vehicle charging system 100 may be configured to include a charging facility 110 that is supplied with an AC grid electric power 10 and provides charging power, an electric vehicle 120 that is supplied with charging power from the charging facility 110, and the like.

The charging facility 110 may be an electric vehicle supply equipment (EVSE). Therefore, the charging facility 110 may be configured to include an off-board charger 111, a controller 112, and the like.

The off-board charger 111 may perform a function of being supplied with AC electric power from the AC grid electric power 10, converting the AC electric power into charging power, and then supplying the charging power to the electric vehicle 120. The off-board charger 111 may be a bidirectional charger. To this end, the off-board charger 111 may be configured with a rectifier, a direct current power supplier, and the like.

The controller 112 may perform a function of controlling the off-board charger 111. To this end, the controller 112 may be configured to include a microprocessor, a microcomputer, a communication circuit, a memory, a display, an input means, and the like. The display may be a touch screen or the like. Therefore, the display may possibly function as both an input means and an output means. The input means may be a button, a microphone, or the like.

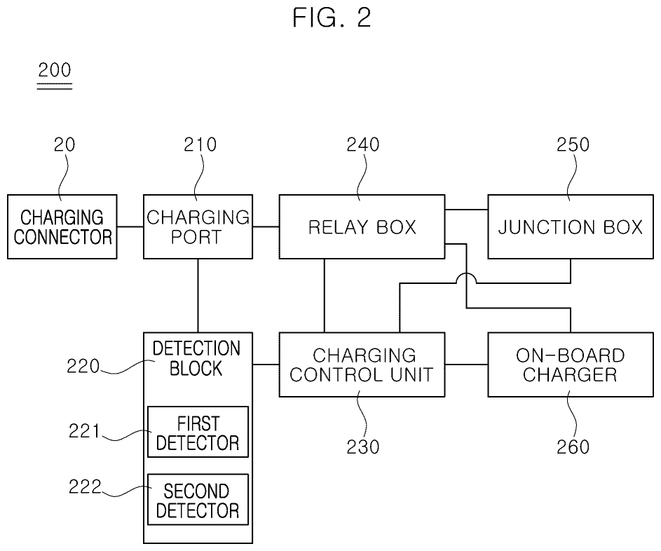

FIG. 2 is a block diagram illustrating a configuration of a charging apparatus 200 for the electric vehicle 120 according to an exemplary embodiment of the present disclosure, which is configured to be mounted in the electric vehicle 120 illustrated in FIG. 1. With reference to FIG. 2, the charging apparatus 200 for the electric vehicle 120 may be configured to include a charging port 210, a detection block 220, a charging control unit 230, a relay box 240, a junction box 250, an on-board charger 260, and the like.

The charging port 210 may be connected to a charging connector 20 of the charging facility 110 and may perform a function of transferring charging power and/or a control signal. The charging port 210 may be configured as a charging port complying with the standard for the Combined Charging System (CCS mode) and/or a charging port complying with the North American Charging Standard (NACS mode). Of course, the charging port 210 may have a different shape with slow and quick charging modes.

Several terminals (not shown), which are fastened to several pins (not illustrated) formed in the charging connector 20 of the charging facility 110, may be configured to be formed in the charging port 210. Of course, the pins and the terminals may be formed in a manner that varies according to the CCS mode and/or the NACS mode.

The detection block 220 may perform a function of detecting whether or not the charging connector 20 is correctly connected to the charging port 210 and then generating a detection signal. When the charging connector 20 is not properly engaged with the charging port 210, the detection block 220 may perform a function of detecting this non-engagement and transferring a detection signal thereof to the charging control unit 230.

Of course, a plurality of the detection blocks 220 may be provided for configuration. That is, the detection block 220 may be configured to include a first detector 221 installed at the charging port complying with the NACS mode and a second detector 222 installed at the charging port complying with the CCS mode. Proximity sensors, infrared sensors, or similar sensors, which utilize a difference between the charging connector 20 and the charging port 210, may also be used as the first and second detectors 221 and 222. Of course, the first and second detectors 221 and 222 may be electric current sensors or voltage sensors that are capable of detecting electric current or voltage, respectively, that flows in some amount due to the connection of the connector 20 and the charging port 210.

The charging control unit 230 may perform a function of performing charging control in compliance with either the CCS mode or the NACS mode according to the detection signal. That is, the relay box 240 and/or the junction box 250 may be controlled according to whether the charging port 210 complies with the CCS mode or the NACS mode. To this end, the charging control unit 230 may be configured to include a microcomputer, a microprocessor, an electronic circuit, a communication circuit, a memory, and the like.

The memory may be configured as a combination of a non-volatile memory and a volatile memory. Examples of the non-volatile memory include a solid-state disk (SSD), a hard disk drive, a flash memory, an electrically erasable programmable read-only memory (EEPROM), a static RAM (SRAM), a ferro-electric RAM (FRAM), a phase-change RAM (PRAM), a magnetic RAM (MRAM), and the like. Examples of the volatile memory include a dynamic random-access memory (DRAM), a synchronous dynamic random-access memory (SDRAM), a double data rate-SDRAM (DDR-SDRAM), and the like.

According to the charging control by the charging control unit 230, the relay box 240 may perform a function of separating charging power supplied from the charging facility 110 into direct current power and alternating current power and relaying the direct current power and alternating current power to the junction box 250 and/or the on-board charger 260.

The junction box 250 may perform a function of allowing or disabling the flow of direct current power into a battery.

The on-board charger 260 may perform a function of being supplied with alternating current power and converting the alternating current power into direct current power for charging. Typically, a charging operation of the electric vehicle may be categorized into two types: a slow charging mode and a quick charging mode. The slow charging mode is a type of battery charging using direct current power which is converted from an alternating current power of approximately 20 V.

In contrast, the quick charging mode is a type of battery charging using direct current high voltage directly without passing through the on-board charger 260. To this end, the on-board charger 260 may be configured to include power factor correction (PFC), an alternating current-direct current (AC-DC) converter, a rectifier, and the like.

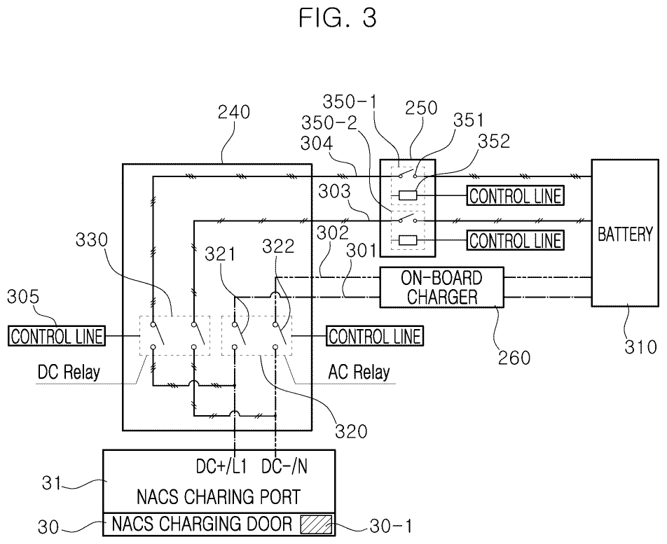

FIG. 3 is a block diagram illustrating detailed configurations of the relay box 240 and the junction box 250, illustrated in FIG. 2, that are applicable for the NACS mode. With reference to FIG. 3, the relay box 240 may be configured with an AC relay 320 for allowing or disabling the flow of alternating current power and a DC relay 330 for allowing or disabling the flow of direct current power.

The AC relay 320 and the DC relay 330 may be configured in parallel with each other, resulting in separate lines. That is, the resulting separate lines are an alternating current power line (denoted by reference numerals 301 and 302) and a direct current power line (denoted by reference numerals 303 and 304).

The alternating current power line (301 and 302) is configured with a Li line 301 and an N line 302. The direct current power line (303 and 304) is configured with a DC− line 303 and DC+ line 304. The Li line 301 and the N line 302 are lines for alternating current power.

In a NACS charging port 31, the DC+ line may be used with the Li line in a common manner, and the DC− line may be used with the N line in a common manner. Of course, CP, PD, and GND lines are present, and these lines are connected to the charging control unit 230 through a NACS charging door 30 and the NACS charging port 31. The NACS charging door 30 may be shaped to be opened and closed and has application in opening and closing the NACS charging port 31. Of course, a first contact point sensor 30-1 may be installed on the NACS charging door (that is, a first charging door) 30. When the NACS charging door 30 is open or closed, the first contact point sensor 30-1 may transmit an open state or a closed state, respectively, to the charging control unit 230.

Typically, specifications for the charging connector and the charging port may be shown in Table 1 that follows.

TABLE 1

| | |
|---|---|
| L1 | AC Power |
| L2/N | AC Power |
| CP | Control Pilot |
| PD | Proximity Detection |
| PE | Ground |
| DC+ | Power supply (+) |
| DC− | Power supply (−) |

A first switching element 321 and a second switching element 322 for switching-on and -off are configured to be in parallel with each other on the AC relay 320. A first switching element 321 and a second switching element 322 for switching-on and -off are configured to be in parallel with each other on the DC relay 330. The first switching element 321 and/or the second switching element 322 are connected to the charging control unit 230 through the control line 305. Therefore, the charging control unit 230 may switch on or off the first switching element 321 and/or the second switching element 322.

Power relays may be primarily used as the first switching element 321 and the second switching element 322. However, the first switching element 321 and the second switching element 322 may not be limited to the power relays. Semiconductor switching elements, thyristors, gate turn-off (GTO) thyristors, triodes for alternating current (TRIACs), silicon-controlled rectifiers (SCRs), integrated circuits, and the like may be used as the first switching element 321 and the second switching element 322. The semiconductor switching elements include field effect transistors (FETs), metal oxide semiconductor FETs (MOSFETs), insulated gate bipolar mode transistors (IGBTs), power rectifying diodes, and the like.

Particularly, semiconductor elements, including electric-power metal oxide silicon field effect transistor (MOSFET) elements and the like, may be used as the first switching element 321 and the second switching element 322. Unlike a typical MOSFET, the electric-power MOSFET element operates at high voltage and high current levels and employs a double-diffused metal oxide semiconductor (DMOS) structure.

Operating conditions for the AC relay 320 and the DC relay 330 are shown in Table 2 that follows.

TABLE 2

| | DC charging | AC charging |
|---|---|---|
| DC Relay | ON | OFF |
| AC Relay | OFF | ON |

As illustrated in FIG. 3, within the relay box 240, line separation occurs by the AC relay 320 and the DC relay 330. Within the relay box 240, an output AC line may be converted into a DC power line through the on-board charger 260 and may be connected to a high-voltage battery 310, and a DC line may be connected to the high-voltage battery 310 through the high-voltage junction box 250.

The AC relay 320 and the DC relay 330 are always in an open state. When performing AC charging, the AC relay 320 may be switched on, and when performing DC charging, the DC relay 330 may be switched on.

The junction box 250 may be arranged between the relay box 240 and the battery 310. The junction box 250 performs a function of allowing or disabling the flow of direct current power into the battery 310. To this end, the junction box 250 may be configured with first and second junction switching elements 350-1 and 350-2 arranged in parallel with each other.

That is, a first junction switching element 350-1 may be connected to a DC+ line 304, and a second junction switching element 350-2 may be connected to a DC− line 303.

Power relays may be primarily used as the first and second junction switching elements 350-1 and 350-2. Therefore, the first and second junction switching elements 350-1 and 350-2 each is configured with a contact point portion 351 and a coil 352 that operates the contact point portion 351.

Of course, semiconductor switching elements, thyristors, gate turn-off (GTO) thyristors, triodes for alternating current (TRIACs), silicon-controlled rectifiers (SCRs), integrated circuits, and the like may be used as the first and second junction switching elements 350-1 and 350-2. The semiconductor switching elements include field effect transistors (FETs), metal oxide semiconductor FETs (MOSFETs), insulated gate bipolar mode transistors (IGBTs), power rectifying diodes, and the like.

The first and second junction switching elements 350-1 and 350-2 may be connected to the charging control unit 230 through the control line 305. Therefore, the first and second junction switching elements 350-1 and 350-2 perform a switching-on operating or a switching-off operation according to a switching-on or switching-off signal of the charging control unit 230.

The battery 310 may be configured by arranging battery cells (not illustrated) in series and/or in parallel. These battery cells may include high voltage battery cells for electric vehicles, such as nickel metal battery cells, lithium-ion battery cells, lithium polymer battery cells, lithium sulfur battery cells, sodium sulfur battery cells, and solid-state battery cells. Typically, the battery cells refer to batteries with voltages of 100 V or higher, which are used as sources for motive power to drive electric vehicles. However, the battery cells may not be limited to such batteries. Batteries with voltages of less than 100 V may also be used as the sources for motive power.

Of course, the battery 310 may be configured to include a battery management system (BMS). The BMS serves to increase energy efficiency and prolong the lifespan of an electric vehicle battery by optimizing management thereof. The BMS prevents excessive charging and discharging by monitoring battery voltage, current, and temperature, and thus increases battery safety and reliability.

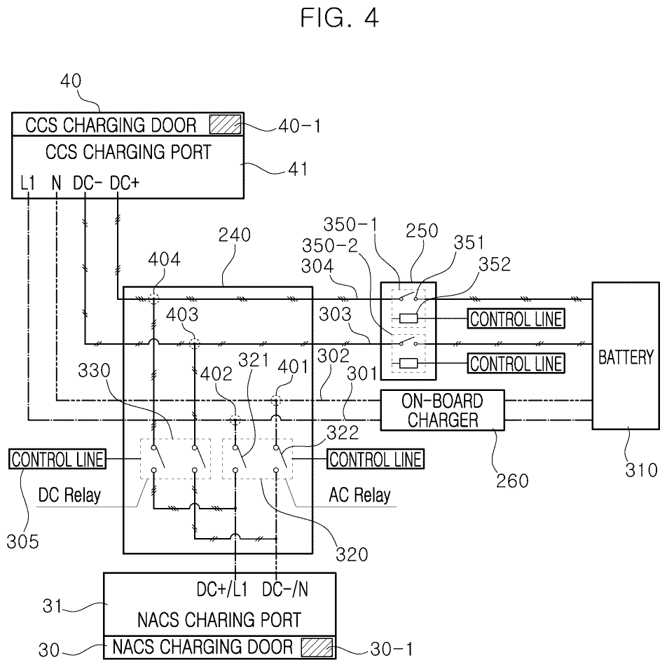

FIG. 4 is a block diagram illustrating detailed configurations of the relay box 240 and the junction box 250 that are applicable for both the standard for the Combined Charging System (CCS) and the North American Charging Standard (NACS). With reference to FIG. 4, the NACS charging port 31 and a CCS charging port 41 may be configured together. Of course, a CCS charging door (that is, a second door) 40 may be provided on the CCS charging port 41 side in the shape that is openable and closable, so that the CCS charging door opens or closes the CCS charging port 41. A second contact point sensor 40-1, capable of checking opening or closing of the CCS charging door 40, may also be installed on the CCS charging door 40. When the CCS charging door 40 is open or closed, the second contact point sensor 40-1 may transmit an open state or a closed state to the charging control unit 230.

The first and second contact point sensors 30-1 and 40-1 each may be configured with a magnet and a main body. When the magnet and the main body come close to each other, a contact point may be switched on (that is, closed). When the magnet and the main body move away from each other, the contact point may be switched off (that is, open). The first and second contact point sensors 30-1 and 40-1 each may convert these states into signals and transmit the signals to the charging control unit 230. Of course, an infrared sensor or the like that uses a distance measurement may be used.

An Li line, an N line, a DC− line, and a DC+ line of the CCS charging port 41 may be connected to first to fourth connection points 401 to 404, respectively, within the relay box 240. In other words, the Li line may be connected to the first connection point 401, the N line to the second connection point 402, the DC− line to the third connection point 403, and the DC+ line to the fourth connection point 404.

Of course, the first connection point 401 may be connected to the Li line 301 of the alternating current power line (denoted by reference numerals 301 and 302), and the second connection point 402 to the N line 302 of the alternating current power line (denoted by reference numerals 301 and 302). In addition, the third connection point 403 may be connected to the DC− line 303 of the direct current power line (denoted by reference numerals 303 and 304), and the fourth connection point 404 may be connected to the DC+ line 304 of the direct current power line (denoted by reference numerals 303 and 304).

Therefore, while charging control is performed in compliance with the NACS mode, the charging control may be ended when an open state of the CCS charging door 40 is detected by the second contact point sensor 40-1. That is, the charging operation may be ended.

Of course, when charging control is performed in compliance with the CCS mode, the charging control may also be ended when an open state of the NACS charging door 30 is detected by the first contact point sensor 30-1. That is, the charging operation may be ended.

In addition, in a case where the charging control is performed in compliance with the CCS mode, the AC relay 320 and the DC relay 330 both may be switched off. The Li line, the N line, the DC− line, and the DC+ line of the charging port 41 may be kept connected to the first to fourth connection points 401 to 404, respectively, within the relay box 240.

When the charging control is performed in compliance with neither the NACS mode nor the CCS mode, the AC relay 320 and the DC relay 330 may be kept switched off.

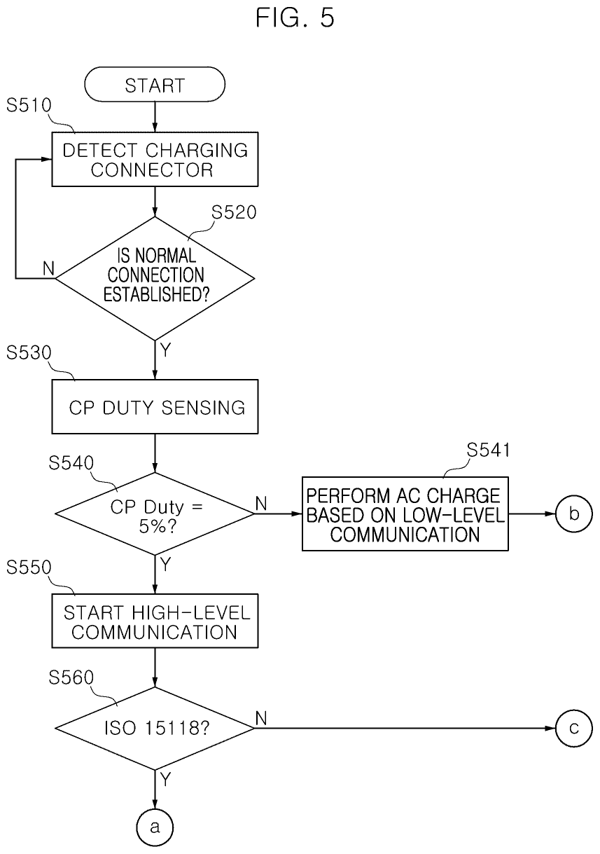

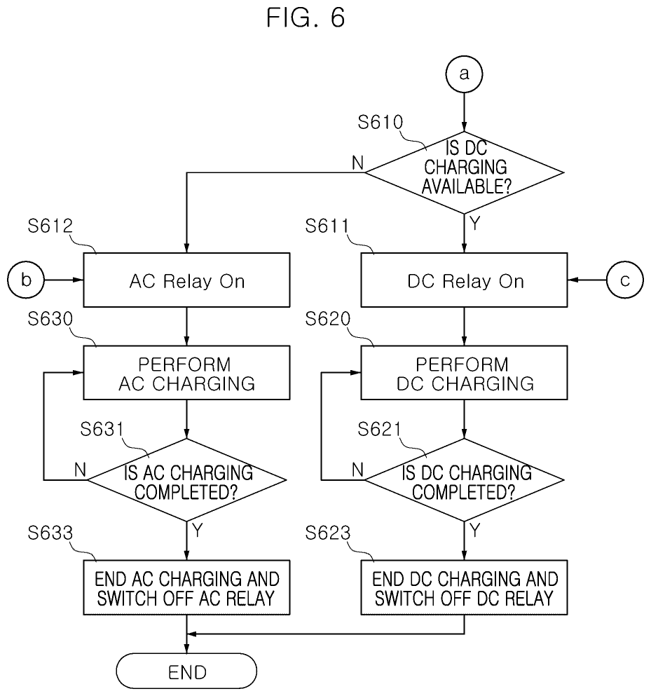

FIGS. 5 and 6 are flowcharts for a method of charging an electric vehicle according to an exemplary embodiment of the present disclosure by determining an AC charging mode and a DC charging mode. First, with reference to FIG. 5, the charging control unit 230 may detect, through the detection block 220, whether or not the charging connector 20 is connected to the charging port 210 (Step S510).

Subsequently, the charging control unit 230 may check, through the detection block 220, whether or not a connection between the charging connector 20 and the charging port 210 is normal (Step S520).

When the result of the checking in Step S520 is that the connection is not normal, a warning signal may be output to a driver and Steps S510 and S520 may be repeated. Of course, through a high-level control unit (not illustrated), the warning signal may be output in the form of a voice, a graphic, and/or a combination of letters. To this end, the high-level control unit may include a display, a sound system, and the like. Examples of the high-level control unit may include an electronic control unit (ECU), a hybrid control unit (HCU), and the like.

When the result of the checking in Step S520 is that the connection is normal, a control pilot (CP) duty may be sensed, and it is checked whether or not the CP duty corresponds to a reference value (Step S540). In Step S540, it is determined whether low-level communication or high-level communication is available.

The reference value may be approximately 5%. Typically, when the charging connector 20 and the charging port 210 are normally connected to each other, powerline communication (PLC) for transmission and reception may be performed through a CP line between the charging facility 110 and the electric vehicle 120.

When the result of the checking in Step S540 is that the CP duty does not correspond to the reference value, the charging control unit 230 may perform an AC charging operation based on the low-level communication, e.g., CP pulse width modulation (PWM) (Step S541), and subsequently proceed to a step of switching on the AC relay 320 (Step S612 in FIG. 6).

Conversely, when the result of the checking in Step S540 is that the CP duty corresponds to the reference value, the charging control unit 230 may start to perform the high-level communication (Step S550).

When the high-level communication is performed between the charging facility 110 and the electric vehicle 120, communication in compliance with Deutsches Institut für Normung (DIN) 70121 or ISO 15118 is available. Therefore, the charging control unit 230 may check whether or not communication is available in compliance with ISO 15118 (Step S560).

When the result of the checking in Step S560 is that the communication is available in compliance with ISO 15118, based on ISO 15118, the charging control unit 230 may check whether the DC charging or AC charging is available (Step S610 in FIG. 6). In other words, it is checked whether the AC charging in compliance with ISO 15118 or the DC charging in compliance with ISO 15118 is available.

When the result of the checking in Step S610 is that the DC charging is available, the charging control unit 230 may perform the DC charging by switching on the DC relay 330 (Steps S611 and S620 in FIG. 6).

Conversely, when the result of the checking in Step S610 is that the AC charging is available instead of the DC charging, the charging control unit 230 may perform the AC charging by switching on the AC relay 320 (Step S612 and S630).

Subsequently, the charging control unit 230 may check whether the AC charging is completed (Step S631) or whether DC charging is completed (Step S621).

When the result of the checking in Steps S621 and S631 is that the DC charging is not completed or that the AC charging is not completed, the previous steps may be repeated.

Conversely, the result of the checking in Steps S621 and S631 may be that the DC charging is completed or that the AC charging is completed, the charging control unit 230 may end the AC charging or the DC charging by switching off the AC relay 320 (Step S633) or the DC relay 330 (Step S623).

When the result of the checking in Step S560 in FIG. 5 is that the communication is not available in compliance with ISO 15118, proceeding to Step S611 takes place immediately.

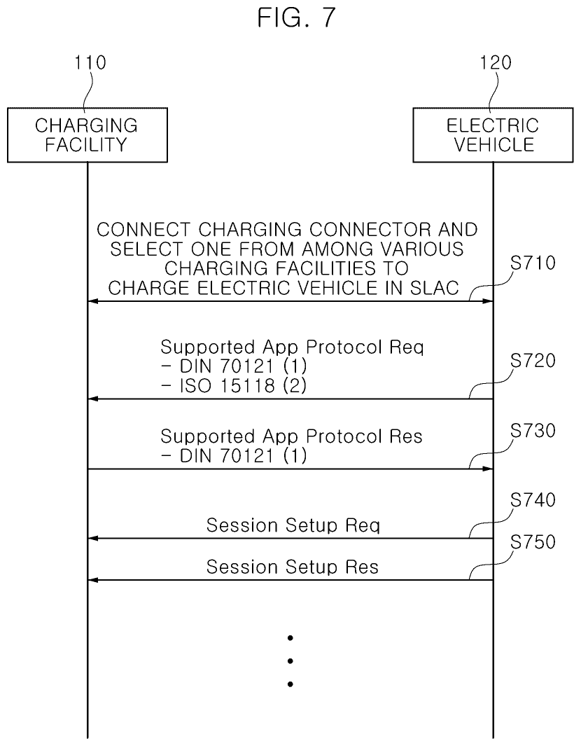

FIG. 7 is a flowchart for performing a process of communication between the charging facility 110 and the electric vehicle 120 according to an exemplary embodiment of the present disclosure. With reference to FIG. 7, when the high-level communication is performed between the charging facility 110 and the electric vehicle 120, the communication may be available in compliance with DIN 70121 or ISO 15118.

A supported app protocol message may be transmitted and received (Step S710). A supply location and charging point (SLAC) may facilitate processes of selecting one from among various charging facilities 110 to charge the electric vehicle 120.

For reference, a communication message that is transmitted and received at this time may be an “Ethernet” message. Through the process in the SLAC, it is determined which charging facility 110 is selected to charge the electric vehicle 120. Thereafter, messages may be exchanged in the given order according to protocols defined in ISO 15118(2) and DIN 70121(1), and the charging operation may be performed (Step S720).

In other words, when the electric vehicle 120 transmits supportable standard protocols in the order of preference, the supportable standard protocols may be compared with standard protocols supported by the charging facility 110 in question. When the same protocol is present, the charging facility 110 may make a response, considering the order of preference for electric vehicles 120 (Steps S730 to S750).

The method or algorithm steps, which are described in association with the embodiments disclosed in this specification may be implemented in the form of program commands executable through various computer components, such as a microprocessor, a processor, and a central processing unit. Therefore, the method or algorithm steps may be recorded on a computer-readable medium. Program (command) codes, data files, data structures, and the like are recorded individually or in combination on the computer-readable medium.

What is claimed is:

1. An apparatus for charging an electric vehicle, the apparatus comprising:
a charging port;
a detection block configured to generate a detection signal by detecting whether or not a charging connector of a charging facility is connected to the charging port;
a charging controller configured to perform charging control using a first charging mode or a second charging mode according to the detection signal; and
a relay box configured to separate charging power supplied from the charging facility into direct current power and alternating current power according to the charging control.

2. The apparatus of claim 1, further comprising a junction box configured to allow or disable a flow of the direct current power into a battery.

3. The apparatus of claim 2, wherein the junction box is arranged between the relay box and the battery and comprises a first junction switching element connected to a DC+ line and a second junction switching line connected to a DC− line.

4. The apparatus of claim 1, further comprising an on-board charger configured to receive the alternating current power and convert the received alternating current power into the direct current power.

5. The apparatus of claim 1, further comprising:
a first contact point sensor configured to detect an open or closed state of a first charging door installed at a charging portion of the charging port complying with the first charging mode; and
a second contact point sensor configured to detect an open or closed state of a second charging door installed at a charging portion of the charging port complying with the second charging mode.

6. The apparatus of claim 5, wherein the charging controller is configured to end the charging control in response to the second charging door being detected as being in the open state while the charging control is performed using the first charging mode or in response to the second charging door being detected as being in the open state while the charging control is performed using the second charging mode.

7. An apparatus for charging an electric vehicle, the apparatus comprising:
a charging port;
a detection block configured to generate a detection signal by detecting whether or not a charging connector of a charging facility is connected to the charging port;
a charging controller configured to perform charging control using a first charging mode or a second charging mode according to the detection signal, the first charging mode comprising a mode complying with the North American Charging Standard (a NACS mode), and the second charging mode comprising a mode complying with a standard for the Combined Charging System (a CCS mode); and
a relay box configured to separate charging power supplied from the charging facility into direct current (DC) power and alternating current (AC) power according to the charging control.

8. The apparatus of claim 7, wherein the detection block comprises:
a first detector disposed at a first charging port complying with the NACS mode and configured to detect a connection to the charging connector; and
a second detector disposed at a second charging port complying with the CCS mode and configured to detect the connection to the charging connector.

9. The apparatus of claim 8, wherein the relay box comprises:
an AC relay connected to an AC power line and configured to allow or disable a flow of the AC power; and
a DC relay arranged in parallel with the AC relay, connected to a DC power line, and configured to allow or disable a flow of the DC power.

10. The apparatus of claim 9, wherein the AC relay and the DC relay are arranged in the AC power line and the DC power line, respectively, and each comprises a plurality of switching elements.

11. The apparatus of claim 9, wherein, in a case where the charging control is performed using the second charging mode, the charging controller is configured to keep a line from the second charging port complying with the CCS mode connected to a connection point within the relay box by switching off both the AC relay and the DC relay.

12. The apparatus of claim 9, wherein, in a case in which the charging control is not performed using one of the first and second charging modes, the charging controller is configured to keep the AC relay and the DC relay switched off.

13. The apparatus of claim 9, wherein, after normally connecting the first charging port complying with the NACS mode or the second charging port complying with the CCS mode to the charging connector, based on a result of a comparison of a control pilot duty with a preset reference value and based on whether or not a specific communication scheme is supported, the charging controller is configured to perform AC charging by switching on the AC relay or perform DC charging by switching on the DC relay.

14. The apparatus of claim 13, wherein, based on the result of the comparison of the control pilot duty with the preset reference value, the AC charging is performed based on low-level communication or high-level communication.

15. The apparatus of claim 13, wherein, based on whether or not the specific communication scheme is supported, either the AC charging or the DC charging is performed or only the DC charging is immediately performed.

16. A method of charging an electric vehicle, the method comprising:
generating, by a detection block, a detection signal by detecting whether or not a charging connector of a charging facility is connected to a charging port;
performing, by a charging controller, charging control using a first charging mode or a second charging mode according to the detection signal; and
separating, by a relay box, charging power supplied from the charging facility into direct current (DC) power and alternating current (AC) power according to the charging control.

17. The method of claim 16, wherein:
the first charging mode comprises a mode complying with the North American Charging Standard (an NACS mode);
the second charging mode comprises a mode complying with a standard for the Combined Charging System (a CCS mode); and
generating the detection signal by the detection block comprises:
detecting, by a first detector, a connection to the charging connector, the first detector being installed at a first charging port complying with the NACS mode; and
detecting, by a second detector, the connection to the charging connector, the second detector being installed at a second charging port complying with the CCS mode.

18. The method of claim 17, wherein the relay box comprises:
an AC relay connected to an AC power line and allowing or disabling a flow of the AC power; and
a DC relay arranged in parallel with the AC relay, connected to a DC power line, and allowing or disabling a flow of the DC power.

19. The method of claim 18, wherein, in a case in which the charging control is performed using the second charging mode, performing the charging control by the charging controller comprises keeping a line from the second charging port complying with the CCS mode connected to a connection point within the relay box by switching off both the AC relay and the DC relay.

20. The method of claim 18, wherein, in a case in which the charging control is not performed using one of the first and second charging modes, performing the charging control by the charging controller comprises keeping the AC relay and the DC relay switched off.
